(19) United States
(12) Patent Application Publication
(10) Pub. No.: US 2006/0098228 A1
(43) Pub. Date: May 11, 2006

(54) Real time frame detection in a film scanner

(75) Inventors: Adith Chandrasekhar, Austin, TX (US); Michael C. Wilder, Dripping Springs, TX (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/984,408

(22) Filed: Nov. 9, 2004

(51) Int. Cl. G06K 15/00

(52) U.S. Cl. 358/1.17

(57) ABSTRACT

A method and apparatus for producing and storing a digital image that electronically represents an image on a filmstrip, wherein the image recording medium is scanned to produce digital pixel data representative of the image content of successive scan lines of the medium, and the digital pixel data from successive scan lines are written to a circular buffer. The location of respective image frames contained in the digital pixel data written to the buffer is detected by analyzing the data written to the buffer using predetermined algorithms, and then the digital pixel data representative of detected image frames is copied into frame buffers before the data on the circular buffer of image frames already copied into image buffers is overwritten with digital pixel data representative of the contents of subsequent scan lines of the image recording medium.

### FIELD OF THE INVENTION

The present invention relates to frame detection for locating the positions of respective images on a strip of film, and is particularly useful in systems that do not permit a pre-scan of the film.

### BACKGROUND OF THE INVENTION

Conventional film digitization processes scan a filmstrip using a conventional electronic scanner to produce a digital image that electronically represents the photographed image. Conventional electronic film scanners generally operate by directing white light through the film negative. The light interacts with the dye clouds the form the image, and the intensity of the colors red, green and blue are recorded by a sensor or sensors. Sensor data is used to produce the digital image.

Automated photographic film handling processes, such as film scanning and printing processes, require the ability to accurately position the film at the location of each exposure (image frame). For example, photo-finishing systems customarily pre-scan a strip of film to accurately identify where each image is located on the filmstrip. When the film is rescanned, this information is used to identify successive frames for rescanning of optical printing. In commonly assigned U.S. Pat. No. 5,414,779, which issued to John Mitch on May 9, 1995, the locations of respective image frames contained on a continuous color photographic filmstrip are identified by storing scan line data produced by the scanner in a digital database, and processing the stored scan line data to generate a predictor space which is used to identify locations of all the minimally valid frames. Thereafter, the image frames are used to produce statistics that are used to detect the location of other frames. Such a process requires a pre-scan, which requires additional time and/or hardware.

A relatively new process, described in commonly assigned U.S. Pat. No. 6,705,777, which issued to Douglas E. Corbin et al. on Mar. 16, 2004, is digital film processing wherein the film is directly scanned during the development process. However, the very act of scanning the film destroys the image. Accordingly, a pre-scan such as described in afore-mentioned U.S. Pat. No. 5,414,779 would itself destroy the usefulness of the film; essentially fogging the film and making it unreadable to the subsequent scan. In some instances, infrared light has been used to scan the film to prevent the film from being fogged when the developing film is to be scanned at different times during the development process.

### SUMMARY OF THE INVENTION

The present invention provides a novel method and apparatus for producing and storing a digital image that electronically represents an image on a filmstrip. The image recording medium is scanned to produce digital pixel data representative of the image content of successive scan lines of the medium, and the digital pixel data from successive scan lines are written to a circular buffer. The location of respective image frames contained in the digital pixel data written to the buffer is detected by analyzing the data written to the buffer using predetermined algorithms, and then the digital pixel data representative of detected image frames is copied into frame buffers before the data on the circular buffer of image frames already copied into image buffers is overwritten with digital pixel data representative of the contents of subsequent scan lines of the image recording medium.

The present invention is particularly useful with high volume digital film scanners that scan an entire roll of uncut photographic film in high resolution. The data from the scanner consists of interspersed frame, gutter, leader and tail information of the film and is continuously written to a circular memory buffer of fixed size. The method and apparatus of the present invention separates frame data from the other information before the buffer is completely filled. The separated frame data can then be either written out to disk or further processed depending on the application.

The present invention automatically segments an entire roll of scanned photographic film into individual frames. Since the algorithm requires a minimum of 1½ and a maximum of 4 frames to perform frame detection, it can process the roll simultaneously as the film is being scanned. This translates directly to a shorter waiting period for a user to obtain images from his or her film negative.

Unlike the prior frame detection, the present invention does not require a pre-scan of the film. Accordingly, it can be run in real-time by using a circular buffer while the film is scanned in high-resolution. The scanner does not need to start and stop scanning for each frame, since it scans the entire roll of film in one pass. This simplifies the hardware and produces higher throughput. The present invention can be used in systems where the act of scanning the film essentially destroys it. It can be used in systems where the film must be scanned within a certain amount of time so as to avoid being fogged.

### BRIEF DESCRIPTION OF THE DRAWINGS

For a more complete understanding of the invention and the advantages thereof, reference is made to the following description taken in conjunction with the accompanying drawings, in which:

FIG. 1 is a schematic diagram of a digital film system in which the present invention is particularly useful;

FIG. 2 is a schematic illustration of the linkage between film to be scanned and a frame detection process;

FIG. 3 is a flow chart illustrating the sequence in which various modes of frame detection are invoked;

FIGS. 4 and 5 are graphs illustrating notch patterns for detection of leading and trailing edges of image frames; and

FIGS. 6-11 are schematic illustrations of filmstrips containing image frames, and are used to describe the present invention.

### DETAILED DESCRIPTION OF THE INVENTION

Before describing in detail the particular image frame detection in accordance with the present invention, it should be observed that the present invention resides primarily in what is effectively a prescribed augmentation of the image scanning control software employed by the control processor which operates the film scanning mechanism at the front end of a digital image processing system, and not in the details of the hardware employed to scan the film. Accordingly, the structure, control and arrangement of conventional components and signal processing circuitry of which such a system is comprised have been illustrated in the drawings by readily understandable block diagrams which show only those specific details that are pertinent to the present invention, so as not to obscure the disclosure with structural details which will be readily apparent to those skilled in the art having the benefit of the description herein. Thus, the block diagram illustrations of the figures do not necessarily represent the mechanical structural arrangement of the exemplary system, but are primarily intended to illustrate the major structural components of the system in a convenient functional grouping, whereby the present invention may be more readily understood.

The following is a general description of various features of the present invention that will be described in some detail later. The invention has been described in detail with particular reference to certain preferred embodiments thereof, but it will be understood that variations and modifications can be effected within the spirit and scope of the invention.

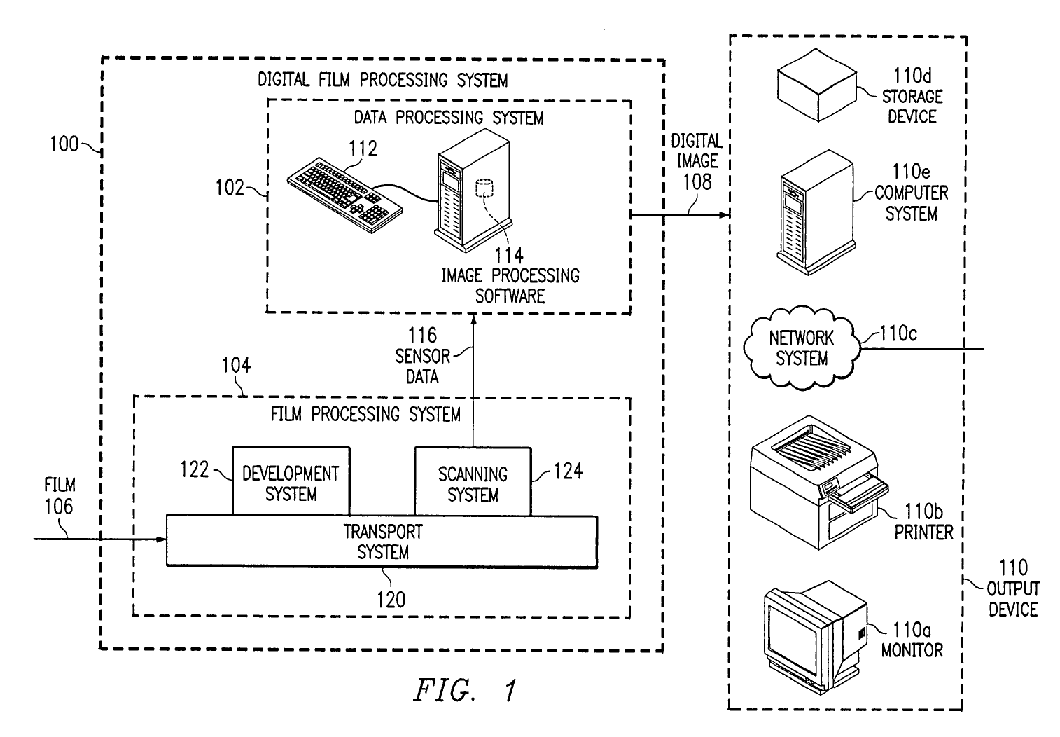

The present invention is best suited for use with high volume digital film scanners that scan an entire roll of uncut photographic film in high resolution. Such a scanner system 100 is shown in FIG. 1, wherein the system 100 comprises a data processing system 102 and a film processing system 104 that operates to digitize a film 106 to produce a digital image 108 that can be output to an output device 110. Film 106, as used herein, includes color, black and white, x-ray, infrared or any other type of film and is not meant to refer to any specific type of film or a specific manufacturer.

Data processing system 102 comprises any type of computer or processor operable to process data. For example, data processing system 102 may comprise a general purpose computer or individual processors, such as application specific integrated circuits (ASICs). Data processing system 102 may include an input device 112 operable to allow a user to input information into system 100. Although input device 112 is illustrated as a keyboard, input device 112 may comprise any input device, such as a keypad, mouse, point-of-sale device, voice recognition system, memory reading device such as a flash card reader, or any other suitable data input device.

Data processing system 102 includes image processing software 114 resident on the data processing system 102. Data processing system 102 receives sensor data 116 from film processing system 104. As described in greater detail below, sensor data 116 is representative of the colors and silver in film 106 at each discrete location, or pixel, of the film. Sensor data 116 is processed by image processing software 114 to produce digital image 108. Image processing software 114 operates to compensate for the silver in film 106. In one embodiment, image processing software 114 comprises software based on U.S. Pat. No. 6,442,301. In this embodiment, any silver remaining in film 106 is treated as a defect and each individual pixel color record is compensated to remove the effect of the silver. Digitally compensating for the silver in film 106 instead of chemically removing the silver from the film substantially reduces or eliminates the production of hazardous chemical effluents that are generally produced during conventional film processing methods. Although image processing software 114 is described in terms of actual software, the image processing software may be embodied as hardware, such as an ASIC. The color records for each pixel form digital image 108; which is then communicated to one or more output devices 110.

Output device 110 may comprise any type or combination of suitable devices for displaying, storing, printing, transmitting or otherwise outputting digital image 108. For example, as illustrated, output device 110 may comprise a monitor 110a, a printer 110b, a network system 110c, a mass storage device 110d, a computer system 110e, or any other suitable output device. Network system 118c may be any network system, such as the internet, a local area network, and the like. Mass storage device 110d may be a magnetic or optical storage device, such as a floppy drive, hard drive, removable hard drive, optical drive, CD-ROM drive, and the like. Computer system 110e may be used to further process or enhance digital image 108.

As described in greater detail below, film processing system 104 operates electronically scan film 106 to produce sensor data 116. Light used to scan film 106 includes light within the visible portion of the electromagnetic spectrum. As illustrated, film processing system 104 comprises a transport system 120, a development system 122, and a scanning system 124. Although system 100 is illustrated with a development system 122, alternative embodiments of system 100 do not require development system 122. For example, film 106 may have been preprocessed and not require the development process described below.

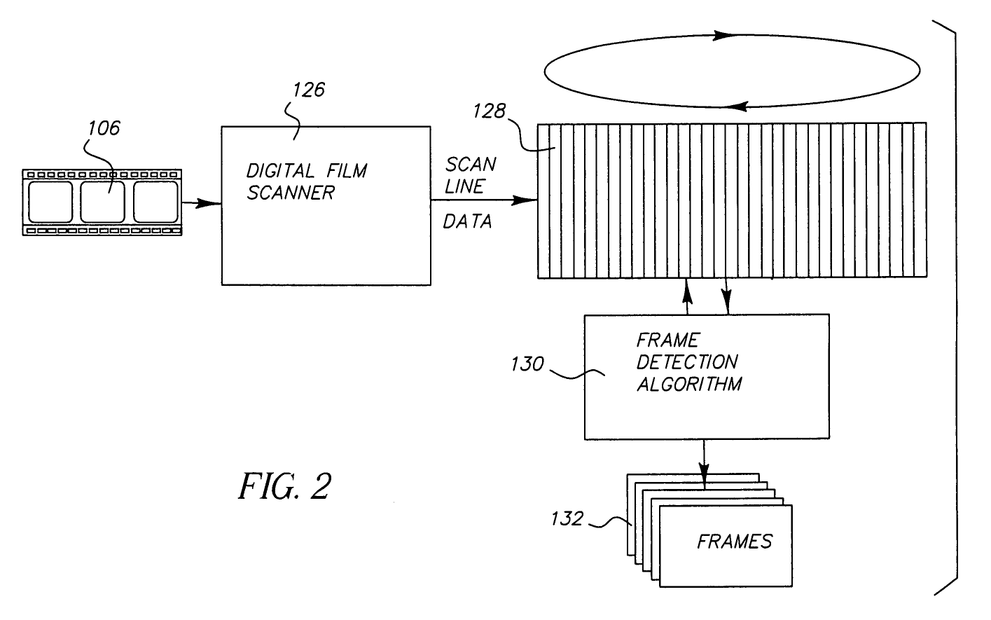

Referring to FIG. 2, data, consisting of interspersed frame, gutter, leader and tail information from film 106 is picked up by a digital film scanner 126, which forms a part of scanning system 124, and is continuously written to a circular memory buffer 128 in data processing system 102. A frame detection algorithm 130 of image processing software 114 separates frame data 132 from the other information before the buffer is completely filled. The separated frame data can then be either written out to disk or further processed depending on the application.

Frame detection (also referred to as frame segmentation) is generally effected by means of a statistical pattern recognition algorithm. The process gathers certain metrics from three channels of each incoming scan line and, using a set of heuristics, analyzes these metrics to determine the boundaries of each frame in the roll.

Frame detection is a two-step process. The first step involves calculation of the metrics for each scan line and the second step involves analysis of the metrics calculated in the first step to determine the frame boundaries and the cropping limits for each frame in the buffer.

In the first step, the calculation of the metrics for each scan line makes use of statistics gathered from each scan line to calculate two features: (1) a first feature known as the “Predictor” and (2) a second feature known as the “Probability”.

For each pixel in a scan line, the red, green and blue values are sorted, and the average of the two largest values is calculated and stored as a vector. The maximum value (max), the mean value (μ), and the standard deviation value (σ) of this vector are calculated. Generally, a certain percentage of the edge pixels in the vector are ignored to avoid edge artifacts in the film. The Predictor is a function of the maximum value (max), the mean value (μ), and the standard deviation value (σ) calculated earlier for each scan line. That is:
Predictor=F(μ,σ,max).
The predictor is a measure of the information in each scan line. Therefore, the greater the amount of information in the scan line, the higher the value of the predictor. The second feature, the probability of the scan line being a gutter is calculated from the Predictor as follows:

$$Probability ( {P}_{g} ) = \frac{1}{1 + {ⅇ}^{L}} , \\ where \text{:}$$

$$L = ( Predictor - A ) ⨯ B .$$

A and B are calibration coefficients that scale the Predictor linearly so that it is centers on zero. That is, when L is less than zero, it is more likely that the scan line belongs to a gutter. Otherwise, if L is greater than zero, it is more likely that the scan line belongs to a frame. If L equals zero, the scan line could belong to either a frame or a gutter.

The values of calibration coefficients A and B are preferably determined by use of training filmstrips. These training filmstrips should have frames and gutters whose characteristics are equivalent to what one might expect in the “real world.” That is, the frames should have a mixture of normally exposed, overexposed and underexposed images. There should be a sampling of both indoor and outdoor shots. Other criteria for the characteristics of the frames of the training film rolls will readily occur to those of ordinary skill in the art. One must then go through the training rolls and separate out the data pertaining to frames and gutters. Care should be taken while segmenting out the data for frames information. It is preferred to use underexposed frames rather than normal or overexposed frames. This decreases the chance of classifying a frame as a gutter but increases the chance of classifying a gutter as a frame. However, the heuristics used in the analysis step are generally found to be more reliable in recovering from a gutter that is falsely identified as a frame than vice versa. Other heuristics would dictate different preferences of exposure.

Once the Predictor is calculated from these two datasets separately using the procedure detailed above, The values A and B are calculated such that:
(m1−A)×B=−3
(m2−A)×B=3
where m1 is the mean of the calculated predictor values for all gutters, and m2 is the mean of the calculated predictor values for underexposed frames.

As mentioned above, frame detection is a two-step process. The first step, involving calculation of the metrics for each scan line has been described immediately above. The second step, which involves analysis of the metrics calculated in the first step to determine the frame boundaries and the cropping limits for each frame in the buffer, will now be discussed.

Frame detection algorithm 130 uses the Probability and the Predictor values generated in the first step to determine the boundaries (the start and end columns) for each frame exposed on a given roll. The algorithm analyzes scan lines in circular buffer 128. Depending on the type of mode in which the detection is taking place, the number of scan lines in the buffer can vary from an equivalent of 1 1/2 to 4 frames.

When the buffer reaches the critical size, it processes the gutter probabilities for each of these scan lines in one of three processing modes:
1. Normal Processing mode: This is the normal sequence. The algorithm switches to this mode after synchronization for the first frame has been established. Only 1½ frames worth of scan lines are required in the buffer to detect a frame.
2. Re-Sync Processing mode: The algorithm enters this mode when the frame detected in the Normal mode fails verification.
3. Start of Roll Processing mode: When no frames have been detected yet, and the frame detection algorithm is invoked for the first time, the algorithm processes features in this mode. Start of roll processing is a special case of the re-sync mode.

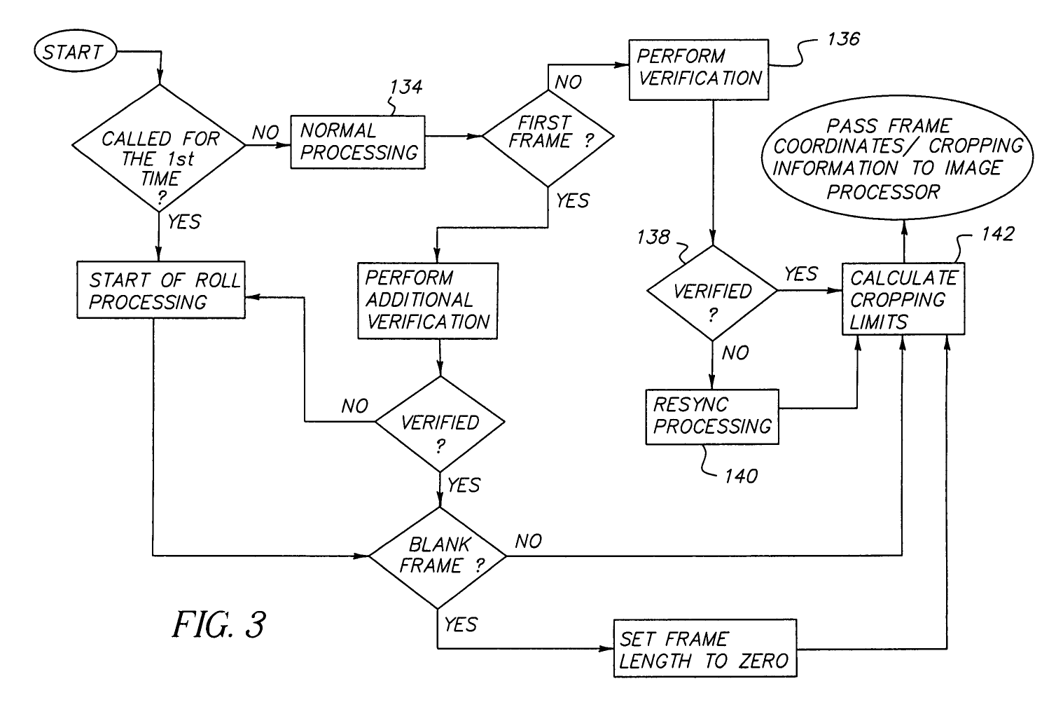

Referring to FIG. 3, the sequence in which the various processing modes are invoked to perform frame detection is outlined below.

Normal Processing Mode

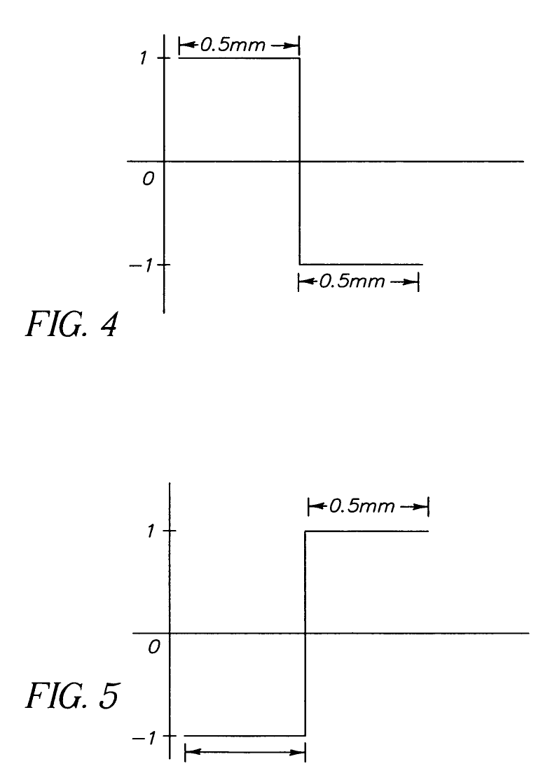

When the algorithm enters the Normal Processing mode 134, it is assumed that the first scan line in the buffer belongs to a gutter. The leading and trailing edges of the subsequent frame are searched for by correlating the vector of gutter probabilities (P_{g}) with a notch pattern as shown in FIG. 4. To find the trailing edge of the frame, the vector of P_{g} is correlated with a mirror image of the notch pattern of FIG. 4 as shown in FIG. 5.

If either the leading or the trailing edge cannot be found, the algorithm estimates one from the other by using the average frame length in that particular roll. If neither edge can be found, the algorithm guesses the location of the two edges by using the average gutter and frame length in that roll.

After the leading and trailing edges of a frame are determined or estimated, a gutter following the trailing edge is searched for. This allows confirmation at Step 136 that the leading and trailing edges are valid. This gutter is detected by adding the gutter probabilities (P_{g}) of the scan lines following the trailing edge. If the sum of these gutter probabilities is below a threshold amount, Step 138 indicates that the edges may be invalid. In such a case the algorithm enters a Re-Sync Processing mode 140. If, on the other hand, the sum of the gutter probabilities is above the threshold, the algorithm calculates the cropping limits at 142 and continues to process scan lines in the Normal Processing mode.

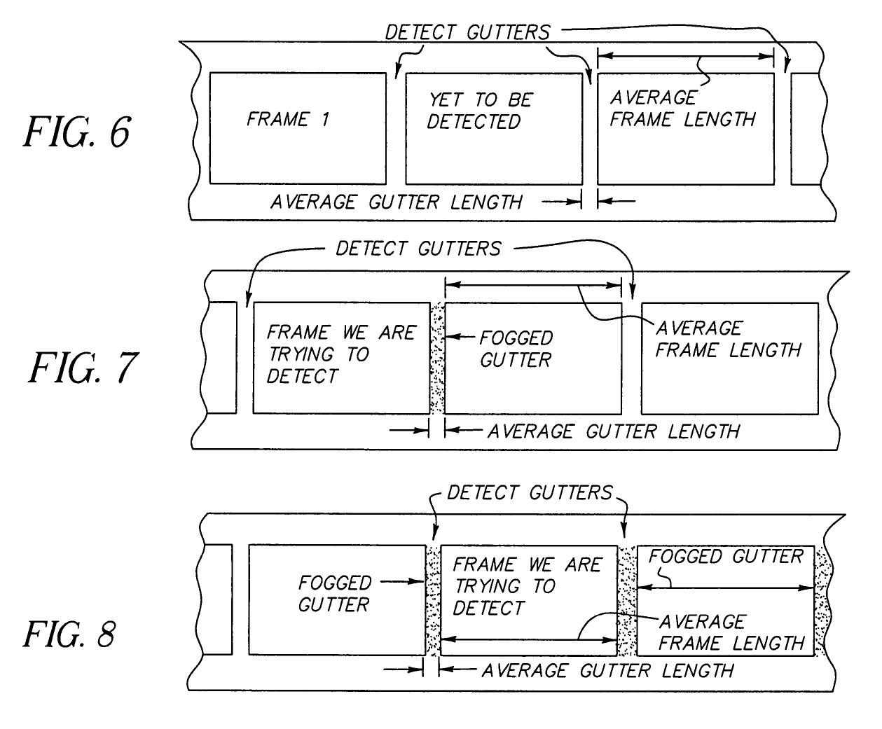

In the Normal mode, additional sync processing is performed after detecting the first frame to ensure that the first frame was detected correctly. Not only is a gutter following the trailing edge checked for, but the existence of gutters for subsequent frames are also checked for, as shown in FIG. 6, using average frame and gutter length statistics, along the scan lines stored in the initial four-frame buffer. If these subsequent gutters are not found, the process enters the Re-Sync Processing mode.

Re-Sync Processing Mode

The algorithm enters this mode when a reasonable frame followed by a well defined gutter cannot be found. The Re-Sync Processing mode consists of two sub-modes:
1. Probability sub-mode: The algorithm looks for two well defined gutters separated by two frames and a gutter's worth of scanlines as shown in FIG. 7. If such a pattern is found, a leading and trailing edge is searched for and force frame output, even if the trailing edge is not followed by a gutter. This mode is especially useful when an overexposed image has bled into the surrounding gutter thereby fogging the gutter. Mathematically, a location i is sought where,

$${S}_{1} = {\sum }_{i}^{i + {L}_{g}} {P}_{g} ( n ) > T , {S}_{2} = {\sum }_{i + 2. {L}_{f} + 2. {L}_{g}}^{i + 2. {L}_{f} + 3. {L}_{g}} {P}_{g} ( n ) > T , and {S}_{1} + {S}_{2 } is maximum .$$

T is a suitably chosen threshold which depends on L_{g}. L_{g} and L_{f} are the average length of a gutter and frame respectively. P_{g}(n) is the probability that the n^{th} scanline belongs to a gutter. If a frame cannot be found using this method, the process switches to the second, Predictor sub-mode. Otherwise, the algorithm switches back to the Normal Processing mode.
2. Predictor sub-mode: Referring to FIG. 8, the Predictor sub-mode is similar to the Probability sub-mode except that the Predictor sub-mode is used to determine the boundaries of a frame. The algorithm generally enters this sub-mode very rarely, especially when a series of gutters is strongly overexposed, whereby all the gutters in the series are detected as frames, or when the gutter sizes vary to a huge degree within the same roll. Again, the process tries to determine a location i such that S₁+S₂ is minimum and S₁+S₂<T, where

$${S}_{1} = {\sum }_{i}^{i + {L}_{g}} p ( n ) , and {S}_{2} = {\sum }_{i + {L}_{f} + {L}_{g}}^{i + {L}_{f} + 2. {L}_{g}} p ( n ) .$$

T is a suitably chosen threshold which depends on L_{g} and the average predictor value of gutter calculated for that particular roll. It is set to a very large value at the start of the roll by default. L_{g} and L_{f} are the average length of a gutter and frame respectively, and p(n) is the predictor value of the n th scanline.

If the frame is still not numerically discernible by this method, the frame is predicted simply on history and the algorithm switches back to the Normal Processing mode. Once the coordinates of a frame are determined in the Re-Sync Processing mode, the start and end points are further refined by searching for edges just as in the Normal Processing mode.

Start of Roll Processing Mode

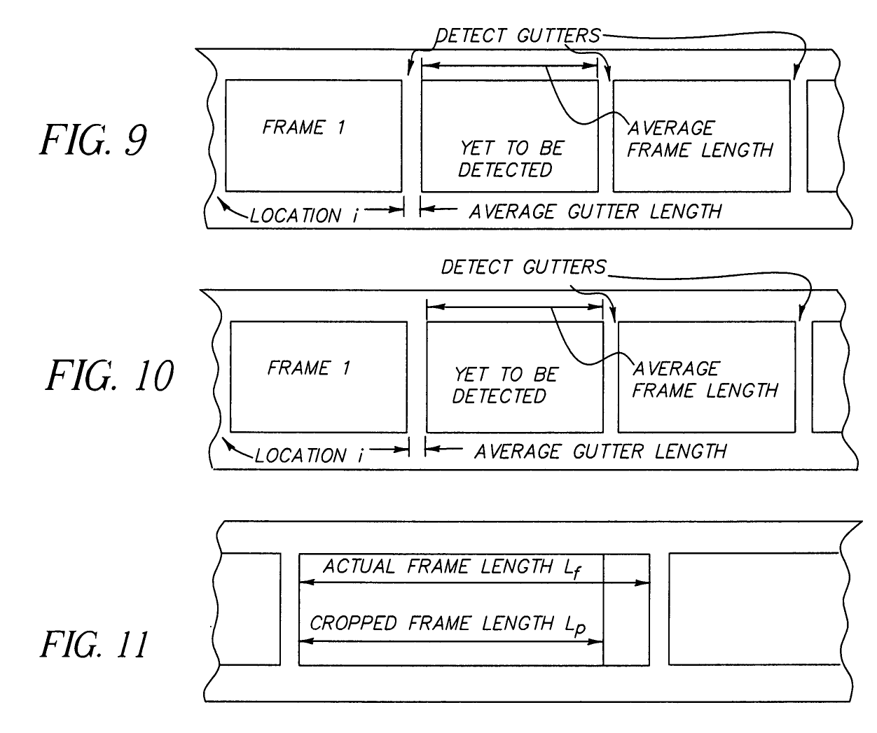

This is a special case of the previously-described Re-Sync Processing mode. By default, when the frame detection algorithm is invoked for the first time on a roll, the system switches to the Start of Roll Processing mode. It also switches to this mode when a first frame has not been detected and the verification step for the Normal Processing mode failed. Just like the Re-Sync Processing mode, the Start of Roll Processing mode has probability and predictor sub-modes.
1. Probability sub-mode: Referring to FIG. 9, the algorithm looks for three well defined gutters separated by two frames. Similar to the Re-Sync Processing mode, we determine a location i such that S₁+S₂+S₃ is maximum, where

$${S}_{1} = {\sum }_{i + {L}_{f} + {L}_{g}}^{i + {L}_{f} + 2. {L}_{g}} {P}_{g} ( n )$$

$${S}_{2} = {\sum }_{i + 2 {L}_{f} + 2 {L}_{g}}^{i + 2 {L}_{f} + 3 {L}_{g}} {P}_{g} ( n )$$

$${S}_{3} = {\sum }_{i + 3 {L}_{f} + 3 {L}_{g}}^{i + 3 {L}_{f} + 4 {L}_{g}} {P}_{g} ( n )$$

L_{g} and L_{f} are the average length of a gutter and frame respectively, and P_{g}(n) is the probability that the n^{th} scanline belongs to a gutter. If a frame cannot be found using this method, i.e. S₁+S₂+S₃ is the same value throughout the search area, then the algorithm switches to the predictor sub-mode. Otherwise, it returns to the Normal Processing mode.
2. Predictor sub-mode: In a manner similar to the Re-Sync predictor sub-mode, the algorithm seeks to find a location i that will minimize S₁+S₂, where

$${S}_{1} = {\sum }_{i + 2 {L}_{f} + 2 {L}_{g}}^{i + 2 {L}_{f} + 3 {L}_{g}} p ( n )$$

$${S}_{2} = {\sum }_{i + 3 {L}_{f} + 3 {L}_{g}}^{i + 3 {L}_{f} + 4 {L}_{g}} p ( n )$$

L_{g} and L_{f} are the average length of a gutter and frame respectively, and p(n) is the Predictor value of the n th scanline. See FIG. 10. If the frame is still not numerically discernible by this method, the location of the frame is guessed to be at a half frame length from the beginning of the roll.

The algorithm then switches back to the Normal mode of Processing.

Determining Cropping Limits

With reference to FIG. 11, an algorithm that adaptively determines the crop limits for each frame within the roll is used to crop the full-sized frame to the expected width. The algorithm analyzes the Predictor values of the scan lines that make up the frame and chooses the set of contiguous scan lines that contain the most amount of image detail within the frame. By doing so, the algorithm intelligently avoids underexposed edges of frames that may contain traces of gutter. In effect, a location i is sought within certain limits such that the quantity

$${\sum }_{n = i}^{i + {L}_{p}} p ( n )$$

is maximized. Lₚ is the print size of the final image in pixels and i varies between zero and L_{f}−Lₚ, where L_{f} is the length of the detected frame.

If p(n) is constant for all i, meaning there is no maximum value, then the frame's cropping limits are set at the center of the frame; discarding equal number of scan lines from both sides of the frame. If the detected frame length is less than the final print size, i.e. L_{f}<Lₚ, then the cropping limits are set to the entire width of the short frame.

The present invention solves provides automatic detection of an entire roll of photographic film into individual frames. Since the algorithm requires a minimum of 1 1/2 and a maximum of 4 frames to perform frame detection, it can process the roll simultaneously as the film is being scanned. This translates directly to a shorter waiting period for a user to obtain images from his or her film negatives. The invention does not require a pre-scan of the film, and the additional time and hardware associated with a pre-scan. Thus, the invention allows frame detection in processes where the act of scanning destroys the film. Because there is no need for a pre-scan of the film, the process can be run in real-time by using a circular buffer while the film is scanned in high-resolution. The scanner does not need to start and stop scanning for each frame, since it scans the entire roll of film in one pass. This simplifies the hardware and produces higher throughput. It can be used in systems where the film must be scanned within a certain amount of time so as to avoid being fogged.

### PARTS LIST

102 data processing system
104 film processing system
106 film
108 digital image
110 output device
112 input device
114 image processing software
116 sensor data
118 network system
120 transport system
122 development system
124 scanning system
126 digital film scanner
128 circular memory buffer
130 frame detection algorithm
132 frame data
134 Normal Processing mode
136 confirmation step
138 indication step
140 Re-Sync Processing mode
142 cropping limits calculation step

1. A method for producing and storing a digital image that electronically represents an image on a filmstrip; said method comprising the steps of:
scanning the image recording medium to produce digital pixel data representative of the image content of successive scan lines of the image recording medium;
writing the digital pixel data from successive scan lines to a circular buffer;
detecting the location of respective image frames contained in the digital pixel data written to the buffer by analyzing the data written to the buffer using predetermined algorithms;
copying digital pixel data representative of detected image frames into frame buffers; and
overwriting data on the circular buffer of image frames already copied into image buffers with digital pixel data representative of the contents of subsequent scan lines of the image recording medium.

2. A method for producing and storing a digital image that electronically represents an image on a filmstrip as set forth in claim 1 wherein:
the image on the filmstrip consists of interspersed frame, gutter, leader and tail information; and
the detecting step separates frame data from gutter, leader and tail information.

3. A method for producing and storing a digital image that electronically represents an image on a filmstrip as set forth in claim 1 wherein the circular buffer is sized to hold at least 1½ frames of the digital pixel data.

4. A method for producing and storing a digital image that electronically represents an image on a filmstrip as set forth in claim 1 wherein the circular buffer is sized to hold between 1½ frames and 4 frames of the digital pixel data.

5. A method for producing and storing a digital image that electronically represents an image on a filmstrip as set forth in claim 1 wherein the step of detecting the location of respective image frames contained in the digital pixel data includes the steps of:
gathering metrics from the digital pixel data; and
using a set of heuristics to analyze the gathered metrics to determine the boundaries of each image frame.

6. A method for producing and storing a digital image that electronically represents an image on a filmstrip as set forth in claim 1 wherein the step of detecting the location of respective image frames contained in the digital pixel data includes the steps of:
gathering and calculation of metrics for each scan line of the digital pixel data; and
analysis of the calculated metrics using a set of heuristics to determine the boundaries and cropping limits of each image frame in the circular buffer.

7. A method for producing and storing a digital image that electronically represents an image on a filmstrip as set forth in claim 1 wherein the step of detecting the location of respective image frames contained in the digital pixel data includes the steps of:
gathering and calculation of metrics for each scan line of the digital pixel data to calculate a Predictor and a Probability, where the Probability is the probability of the scan line being a gutter, and is determined from the Predictor; and
analysis of the calculated metrics using a set of heuristics to determine the boundaries and cropping limits of each image frame in the circular buffer.

8. A method for producing and storing a digital image that electronically represents an image on a filmstrip as set forth in claim 7 wherein the Predictor is the product of the maximum value, the mean value, and the standard deviation value of a vector of the two largest values of the digital pixel data in a scan line.

9. A method for producing and storing a digital image that electronically represents an image on a filmstrip as set forth in claim 8 wherein the Probability is calculated from the Predictor as follows:
$$Probability ( {P}_{g} ) = \frac{1}{1 + {ⅇ}^{L}}$$
where L=(Predictor−A)×B and A and B are calibration coefficients that scale the Predictor linearly so that it is centered on zero.

10. A scanning system for producing and storing a digital image that electronically represents an image on a filmstrip; said scanning system comprising:
a scanner operable to produce digital pixel data representative of successive scan lines of an image on an image recording medium;
a circular buffer adapted to receive the digital pixel data of successive scan lines produced by said scanner;
a data processing system operable to detect a location of respective image frames contained in the digital pixel data received by the buffer by analyzing the received data using predetermined algorithms; and
frame buffers adapted to receive digital pixel data representative of detected image frames, wherein data on the circular buffer of image frames already copied into image buffers may be overwritten with digital pixel data representative of the contents of subsequent scan lines of the image recording medium.

11. A scanning system as set forth in claim 10 wherein the data processing system is adapted to separate frame data from gutter, leader and tail information interspersed on the filmstrip.

12. A scanning system as set forth in claim 10 wherein the circular buffer is sized to hold at least 1½ frames of the digital pixel data.

13. A scanning system as set forth in claim 10 wherein the circular buffer is sized to hold between 1½ frames and 4 frames of the digital pixel data.

14. A scanning system as set forth in claim 10 wherein the data processing system operable to detect a location of respective image frames contained in the digital pixel data is adapted to:
gather metrics from the digital pixel data; and
determine the boundaries of each image frame by means of a set of heuristics for analyzing the gathered metrics.

15. A scanning system as set forth in claim 10 wherein the data processing system operable to detect a location of respective image frames contained in the digital pixel data is adapted to:
gather and calculate metrics for each scan line of the digital pixel data; and
determine the boundaries and cropping limits of each image frame in the circular buffer by analysis of the calculated metrics using a set of heuristics.

16. A scanning system as set forth in claim 10 wherein the data processing system operable to detect a location of respective image frames contained in the digital pixel data is adapted to:
gather and calculate metrics for each scan line of the digital pixel data to calculate a Predictor and a Probability, where the Probability is the probability of the scan line being a gutter, and is determined from the Predictor; and
determine the boundaries and cropping limits of each image frame in the circular buffer by analysis of the calculated metrics using a set of heuristics.

17. A scanning system as set forth in claim 16 wherein the Predictor is the product of the maximum value, the mean value, and the standard deviation value of a vector of the two largest values of the digital pixel data in a scan line.

18. A scanning system as set forth in claim 17 wherein the Probability is calculated from the Predictor as follows:
$$Probability ( {P}_{g} ) = \frac{1}{1 + {ⅇ}^{L}}$$
where L=(Predictor−A)×B and A and B are calibration coefficients that scale the Predictor linearly so that it is centered on zero.
